(19) United States
(12) Patent Application Publication
(10) Pub. No.: US 2021/0350318 A1
(43) Pub. Date: Nov. 11, 2021

(54) SYSTEM AND COMPUTER PROGRAM FOR REAL-TIME LOCATION TRACKING AND MONITORING OF PRODUCT CONTAINERS

(71) Applicant: Data Telematics, LLC, Monroe, LA (US)

(72) Inventors: Todd Williamson, Monroe, LA (US); Chris Turner, Monroe, LA (US)

(73) Assignee: Data Telematics, LLC, Monroe, LA (US)

(21) Appl. No.: 16/866,780

(22) Filed: May 5, 2020

(51) Int. Cl. G06Q 10/08; G06F 21/62; G06F 16/23; G07C 9/00; H04W 4/029; G01S 19/13

(52) U.S. Cl. CPC G06Q 10/0833; G06Q 10/0838; G06F 21/6218; G06F 16/2379; E05B 65/52; H04W 4/029; G01S 19/13; G07C 2009/00325; G07C 9/00309

(57) ABSTRACT

A system, computer program product and method for real-time location tracking and monitoring of product containers. The system includes a plurality of remote computers in communication with a respective plurality of remote users, a service provider computer, a network interface in communication with the central server and the plurality of remote computers over a shared network, a shared database in communication with the service provider computer, an administrative module configured to onboard the plurality of remote users onto the shared network via the network interface, and a location monitoring module configured to monitor in real-time the status and geographical location of a tote tracker attached to a product container and provide the status and geographical location to at least a portion of the plurality of remote users. The service provider computer is configured to receive location tracking information over a network from the tote tracker, store the location tracking information in the shared database, provide access to the shared network to the plurality of remote computers based on the respective access permission of the one of the plurality of remote users provided by the permissibility network module, and manage access specific portions of the location tracking information for all relevant remote users of the plurality of remote users.

### BACKGROUND OF THE INVENTION

### Field of the Invention

The present invention is generally related to location tracking of product containers, and more particularly to a system and computer program for real-time location tracking and monitoring of product containers.

### Discussion of the Background

It is known in the prior art for shipping companies to utilize a global positioning system (GPS) to track vehicle fleets including, without limitation, truck trailers and/or trucks, railcars and the like. Such systems typically utilize tracking units attached to the vehicle. Each tracking unit typically includes a GPS receiver that is capable of receiving GPS signals from a plurality of GPS satellites and determine the tracking unit's location based on the GPS signals. Upon obtaining its location, the tracking unit typically includes a transmitter capable of reporting the vehicle's location to the vehicle's owner. However, such an arrangement only tracks the location of the vehicle. Notably, a shipping vehicle typically contains numerous product containers which are not independently tracked. As such, location tracking is not possible for such product containers themselves. Such an arrangement, is deficient in that a customer is typically more interested in the current location of the product container itself rather than the location of a shipping vehicle. This problem is exasperated when product containers are split into different shipping vehicle and or the product container is separated from the vehicle such as when a delivery occurs.

Theft of goods or cargo from a shipping vehicle is another deficiency known in the shipping industry. The theft of such goods or cargo may occur at any point along the distribution cycle. For instance, the theft may occur while the goods or cargo are being shipped or at a distribution center or warehouse. Theft of goods or cargo in this manner causes substantial financial losses to the shipper and/or the owner of the goods or cargo.

Thus, there currently exist deficiencies associated with location tracking of product containers, and, in particular, with real-time location tracking and monitoring of product containers.

### SUMMARY OF THE INVENTION

Accordingly, one aspect of the present invention is to provide a system for real-time location tracking and monitoring of product containers. The system includes a plurality of remote computers in communication with a respective plurality of remote users, a service provider computer having a computer program stored in non-transient memory and one or more microprocessors, a network interface in communication with the central server and the plurality of remote computers over a shared network, a shared database in communication with the service provider computer, an administrative module configured to onboard the plurality of remote users onto the shared network via the network interface, and a location monitoring module configured to monitor in real-time the status and geographical location of a tote tracker attached to a product container and provide the status and geographical location to at least a portion of the plurality of remote users. The network interface is configured to receive one or more transactions via the shared network. The plurality of remote computers have shared access to a shared database on the service provider computer over the shared network. The administrative module includes a permission system, a control system and software tools that manages access permissions to the shared network, wherein the permission system is configured to provide access permissions to the plurality of remote users using predefined configuration settings, the control system includes rules that vary for each of the plurality of entities and by the respective role of the plurality of remote users, and wherein the rules define the read, write, edit and delete permissions and access rights to specific portions of the shared data model. The service provider computer is configured to receive location tracking information over a network from a tote tracker, store the location tracking information in the shared database, provide access to the shared network to the plurality of remote computers based on the respective access permission of the one of the plurality of remote users provided by the permissibility network module, and manage access specific portions of the location tracking information for all relevant remote users of the plurality of remote users.

Another aspect of the present invention is to provide a system for real-time location tracking and monitoring of the product container. The system includes a remote server in communication with a plurality of remote computers over a network, a product container tracking apparatus detachably connected to a product container, and a controller. The product container tracking apparatus includes a locking mechanism arranged to attach to a product container door, a cellular communication unit configured to communicate with the remote server, a GPS unit configured to determine a location of the product container tracking apparatus, a memory device for storing a unique identifier for the product container tracking apparatus and data relating to the current status of the product container tracking apparatus, and an accelerometer configured to sense movement of the product container tracking apparatus. The controller is configured to periodically receive the current location of the product container tracking apparatus via the GPS unit, periodically toggle the product container tracking apparatus between a low power mode and an operational power mode, and, upon sensing a starting motion of the product container tracking apparatus by the accelerometer, communicate the unique identifier, location and status of the product container tracking apparatus to the remote sever via the cellular communication unit. The product container tracking apparatus is initially in a low power mode. A timer interrupt causes the product container tracking apparatus to toggle to the operational power mode, communicate the unique identifier, location and status of the product container tracking apparatus to the remote sever via the cellular communication unit, and then toggle the product container tracking apparatus back to the low power mode. The locking mechanism is configured to lock and unlock the product container. The remote server communicates the unique identifier, location and status of the product container tracking apparatus to the plurality of remote computers.

### BRIEF DESCRIPTION OF THE DRAWINGS

A more complete appreciation of the present invention and many of the attendant advantages thereof will be readily obtained as the same becomes better understood by reference to the following detailed description when considered in conjunction with the accompanying drawings, wherein:

FIG. 1A is a perspective view of a tote tracker in a detached arrangement in accordance with an embodiment of the present invention;

FIG. 1B is a front view of a tote tracker in a detached arrangement in accordance with an embodiment of the present invention;

FIG. 1C is a back view of a tote tracker in a detached arrangement in accordance with an embodiment of the present invention;

FIG. 1D is a left view of a tote tracker in a detached arrangement in accordance with an embodiment of the present invention;

FIG. 1E is a right view of a tote tracker in a detached arrangement in accordance with an embodiment of the present invention;

FIG. 1F is a top view of a tote tracker in a detached arrangement in accordance with an embodiment of the present invention;

FIG. 1G is a bottom view of a tote tracker in a detached arrangement in accordance with an embodiment of the present invention;

FIG. 1H is a perspective view of a tote tracker in an attached arrangement in accordance with an embodiment of the present invention;

FIGS. 2A-2E are block diagrams illustrating real-time product container location tracking and monitoring network in accordance with an embodiment of the present invention;

FIGS. 3A-3E are flow charts illustrating a method for real-time location tracking and monitoring in accordance with an embodiment of the present invention; and

FIGS. 4A-4E are block diagrams illustrating an exemplary user interface in accordance with an embodiment of the present invention.

### DETAILED DESCRIPTION OF THE PREFERRED EMBODIMENTS

Referring now to the drawings, wherein like reference numerals designate identical or corresponding parts throughout the several views, preferred embodiments of the present invention are described.

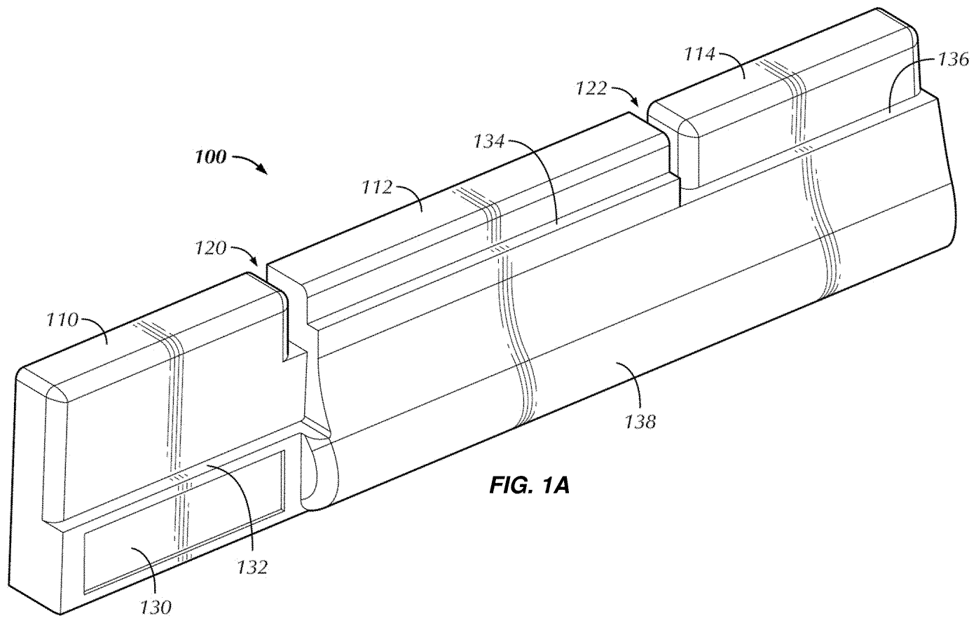

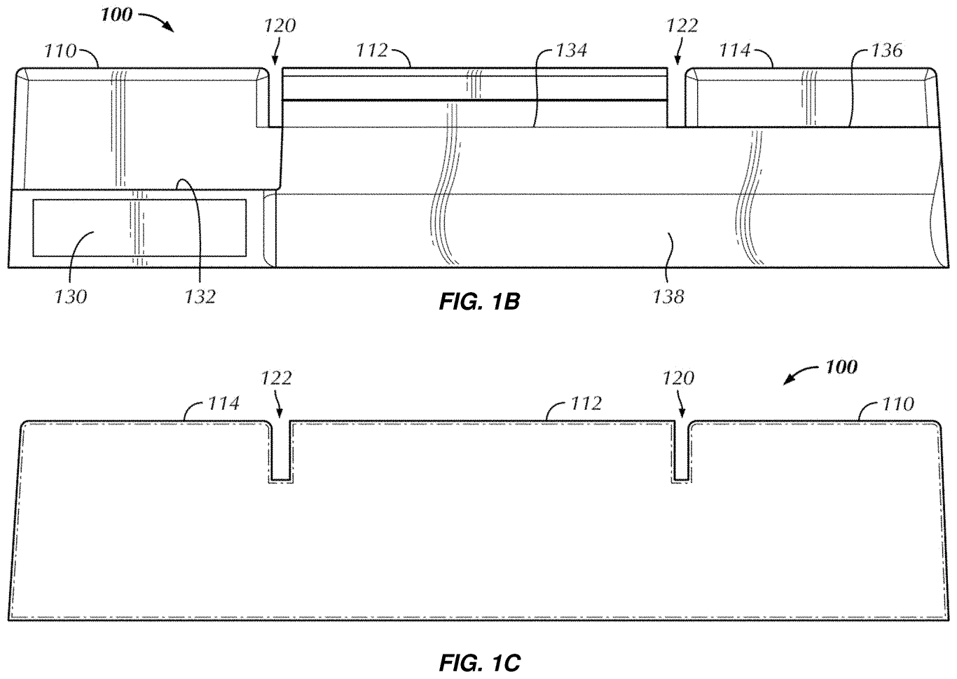

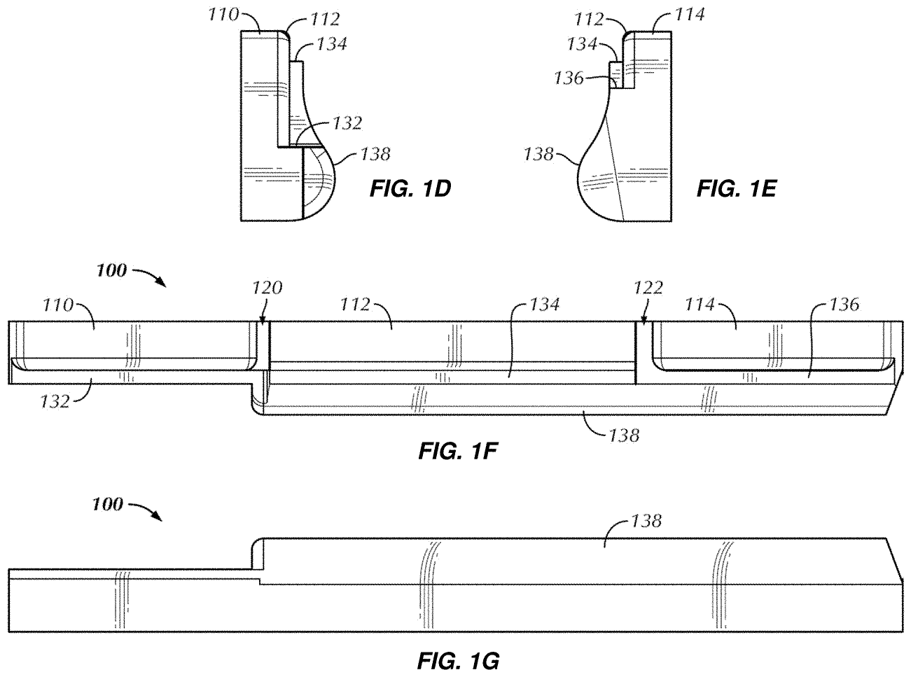

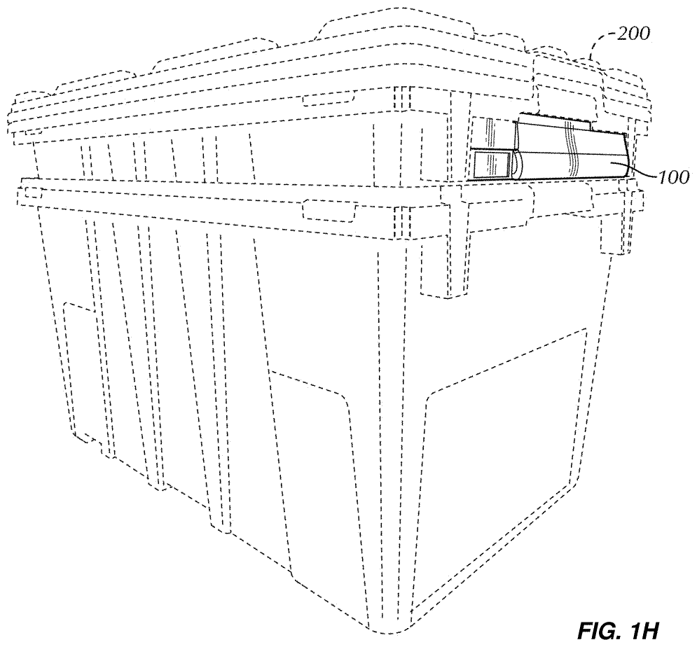

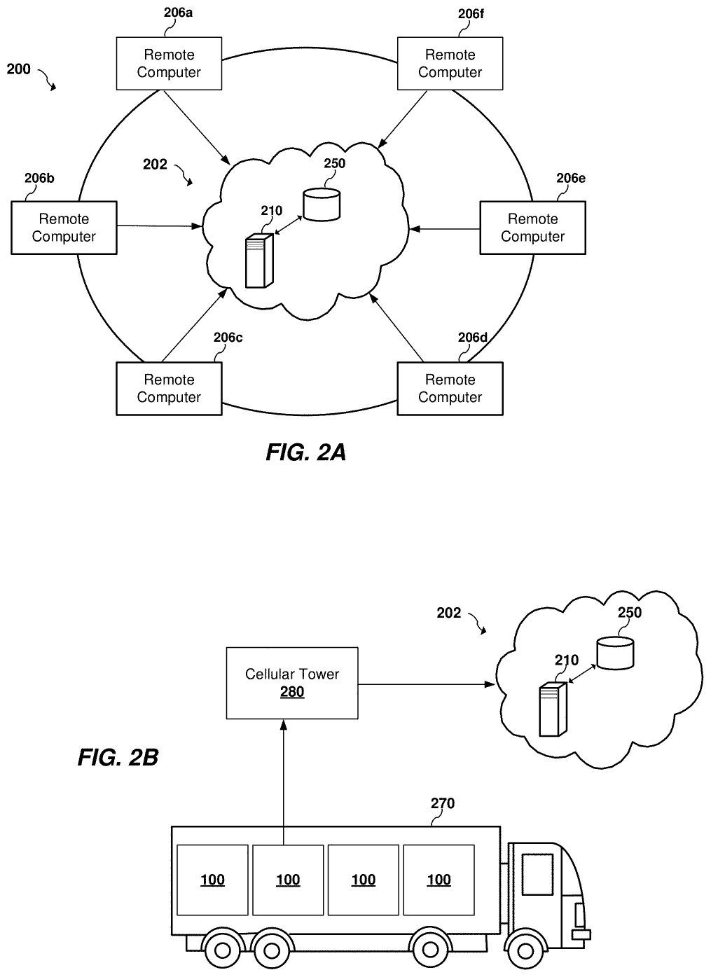

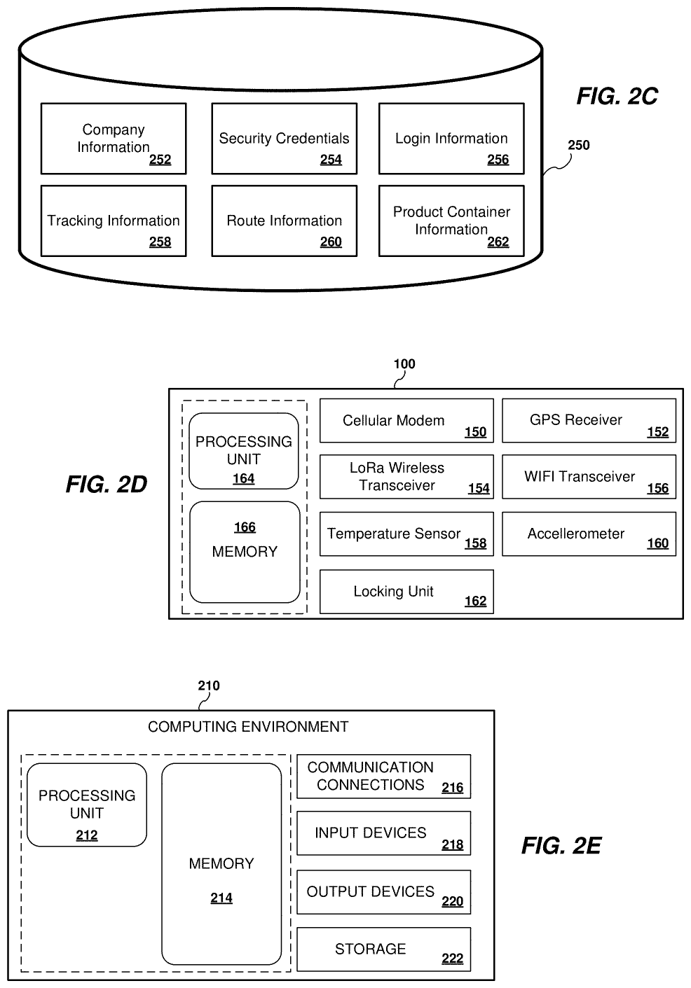

Referring to FIGS. 2A-2E, block diagrams illustrating a non-limiting exemplary real-time product container location tracking and monitoring network in accordance with an embodiment of the present invention, are shown. According to this non-limiting example, computer systems, databases and computer programs associated with the present invention are shown. A plurality of remote computers 206a-206d is associated with one or more companies and/or entities representing a customer base for the present invention. Each company and/or entity, using one or more remote computers 206a-206d, logs-in either directly or indirectly with computer/server 210 and connects with a shared database 250. The login and access to computer/server 210 and shared database 250 are controlled by security credentials 255 and login information 256, which contains without limitation usernames and password information and authorizations to different portions of the present invention. After such log-in or other communication with computer/server 210, each company and/or entity thereby is provided respective access to company information 252, tracking information 258, route information 260, and product container information 262. The route information 260 contains without limitation the shipping schedule associated with one or more product containers 200, each having an attached tote tracker 100 as shown in FIGS. 1A-1H. The route information 260 is typically provided by each company and/or entity using the graphical user interfaces of the present invention. Each tote tracker 100 may be remotely activated or deactivated using without limitation a direct or indirect communication signal from the computer/server 210 to the tote tracker 100. It is understood that any communication signal may be utilized within the scope of the present invention.

After activation of a tote tracker 100, its location is determined using a GPS receiver contained within the tote tracker 100. The location is then transmitted to the computer/server 210 via a communication transmitter contained within the tote tracker 100. Upon receipt, the location of the tote tracker is stored in the tracking information 258 contained within the shared database 250. Transmission frequency of the location of a tote tracker 100 is configurable and may be predefined from a slow intensity transmission frequency to a high intensity transmission frequency. It is understood that the high intensity transmission frequency may include real-time transmission frequencies within the scope of the present invention. The tracking information 258 is provided to the respective companies and/or entities via one or more graphical user interfaces of the present invention.

Referring to FIGS. 1A-1H and FIG. 2D, a tote tracker in accordance with an embodiment of the present invention is shown. In an operational mode, tote tracker 100 is configured to be attached to a product container as shown in FIG. 1H. This attachment may without limitation be by any known means including without limitation, a groove attachment, a clip attachment, an adhesive attachment, a magnetic attachment, a suction attachment and the like. As illustrated in FIG. 2D, according to one embodiment, the tote tracker 100 includes, without limitation, a cellular modem 150, a GPS receiver 152, a LoRa wireless transceiver 154, a WWI transceiver 156, a temperature sensor 158, an accelerometer 160, a locking unit 162, a processing unit (controller) 164 and memory 166. Upon activation, the tote tracker 100 initially maintains a low power mode configuration. The tote tracker 100 monitors for movement of the tote tracker 100 using accelerometer 169. The tote tracker 100 is powered up from its low power mode upon recognition of movement. After the tote tracker 100 is powered up, it uses a low-power LoRa transceiver 154 to attempt to communicate to a gateway device. LoRa is utilized as the primary method of communication because of its the low power requirements. If the tote tracker 100 is able to establish a communication with an external gateway device, then the tote tracker 100 communicates its device ID and GPS location to the gateway device which then relays this information to a backend system. The tote tracker 100 will then power down for a pre-defined period of time, such as, without limitation, 10 minutes. If no movement is detected by the tote tracker 100, then the tote tracker 100 will sleep (a low power mode) for a pre-defined period of time, such as, without limitation, 24 hours.

If no communication is established with a LoRa gateway, then the tote tracker 100 will power up the WIFI transceiver 156 and scan for any WIFI access points within range and available in order to determine its physical location. If no WIFI access points are accessible, then the cellular modem 150 will power up and attempt to make communication with a cell tower. If cell tower is successful, then the tote tracker 100 will power up the GPS receiver 152 and try to determine its GPS location. If the tote tracker 100 is successful in establishing a GPS lock, then it will then send its geographical location information via cellular to a backend system. If the tote tracker 100 is not successful in establishing a GPS lock, then it will attempt to triangulate it location via cell towers (less accurate). It will then send its geographical location information via cellular to a backend system. If cellular communication is not established, the tote tracker 100 will then power back down (into a low power mode) and sleep for up to a predefined period of time, such as, without limitation 24 hours. This will continue unless movement is detected. When movement is detected, the process starts over.

According to one possible configuration, the tote tracker 100 utilizes a SIMCom SIM7000a cellular communication card utilizing a quad-band LTE-FDD and a dual-band GPRS/EDGE. The tote tracker 100 utilizes a low-power wide-area network (LPWAN) technology known as LoRa (Long Range) having a 300 kpbs bit rate and a 915 Mhz base frequency. The tote tracker 100 may be configured to utilize a cellular gateway (through LoRa, long range low power wireless) when in the warehouse or store for communication. However, it is understood that other communication devices, sensors, transceivers and WAN technologies may be utilized within the scope of the present invention.

### User Interfaces

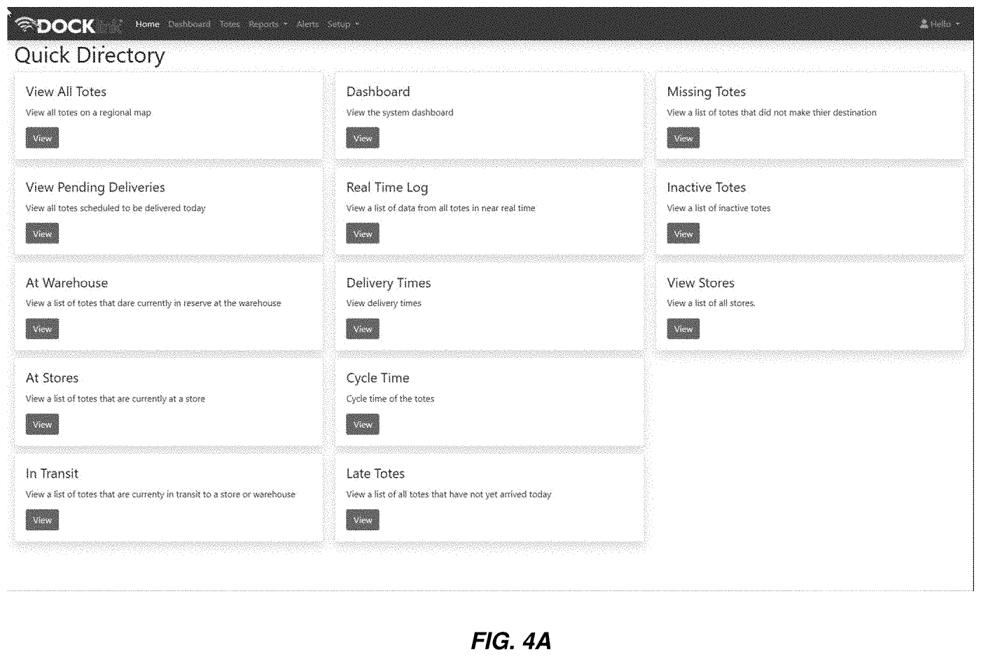

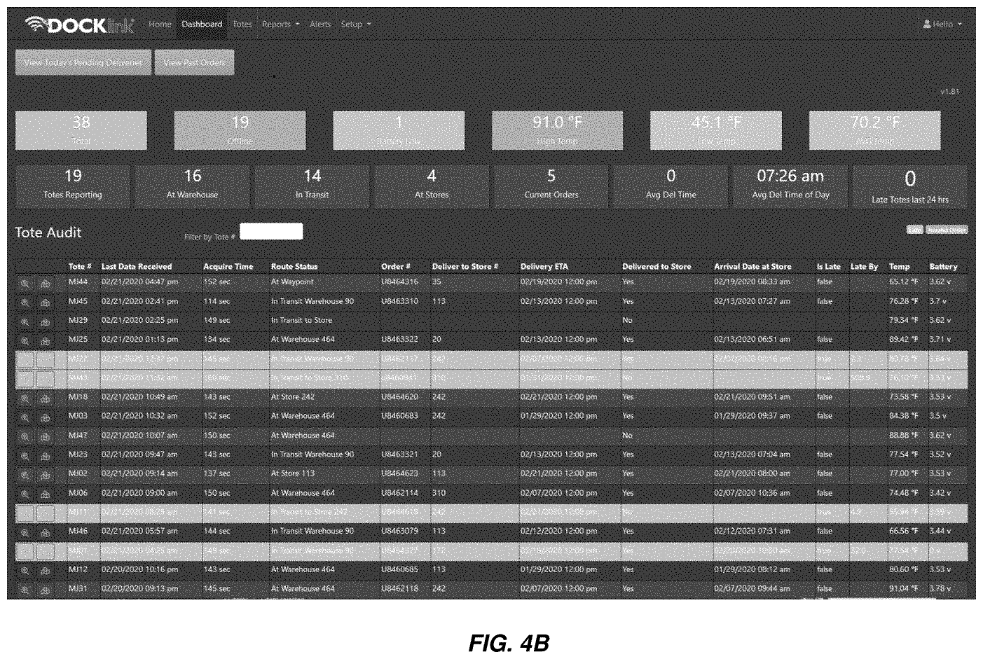

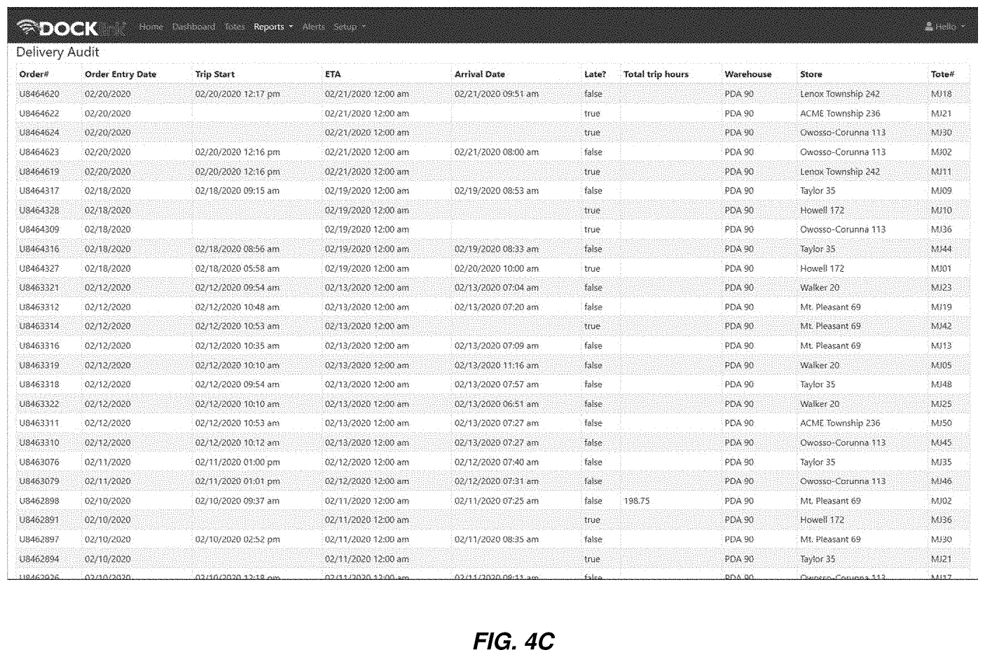

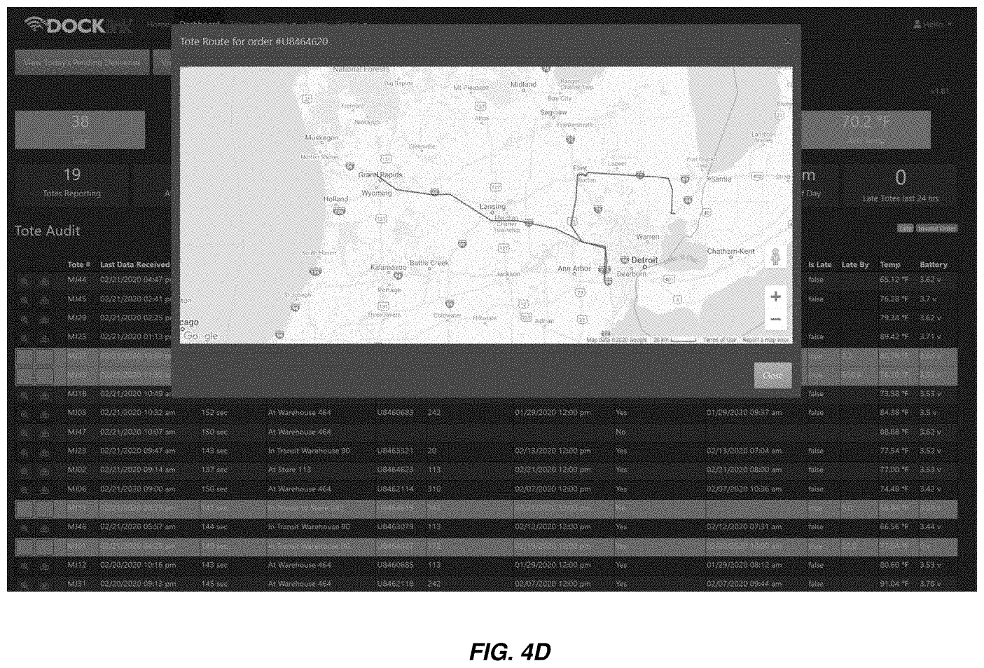

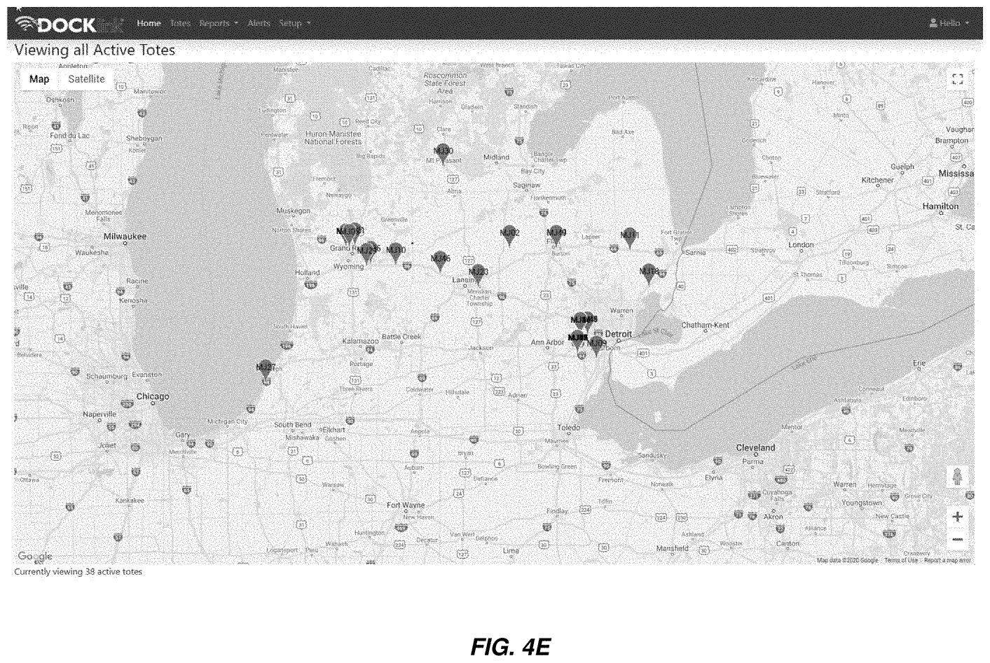

FIGS. 4A-4E are block diagrams illustrating an exemplary user interface in accordance with an embodiment of the present invention. In particular, FIG. 4A shows an exemplary customer home page portal for one or more customers. FIG. 4B shows an exemplary system dashboard providing real-time data and route status. FIG. 4C shows an exemplary tote delivery audit report. FIG. 4D shows an exemplary tote trip history report. FIG. 4E shows an exemplary view of the status of totes and their respective location on a geographical map.

### Processing Flows

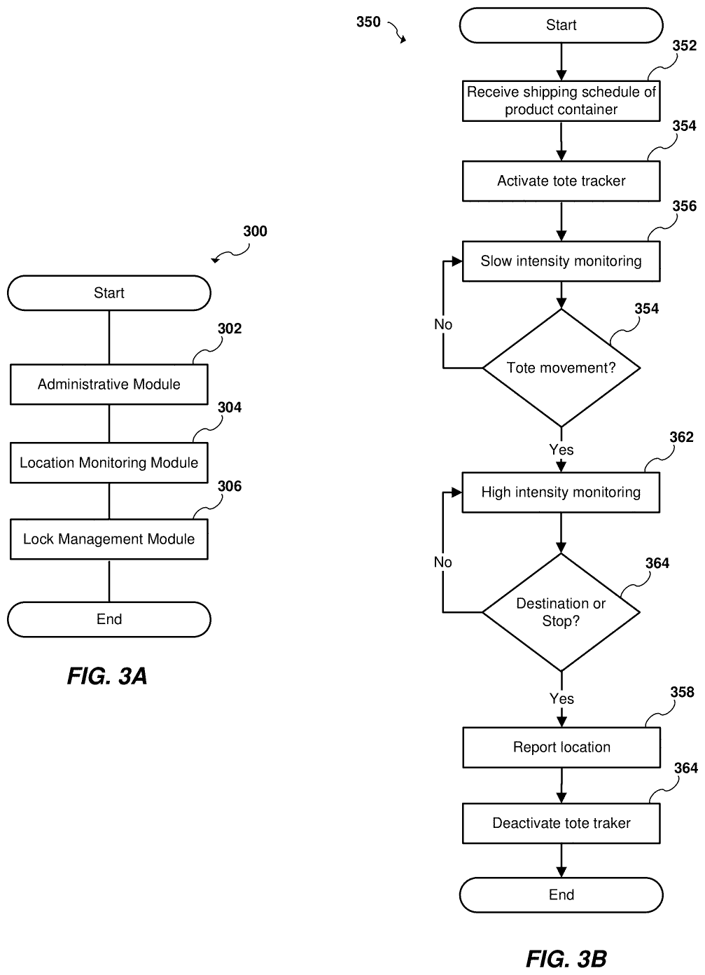

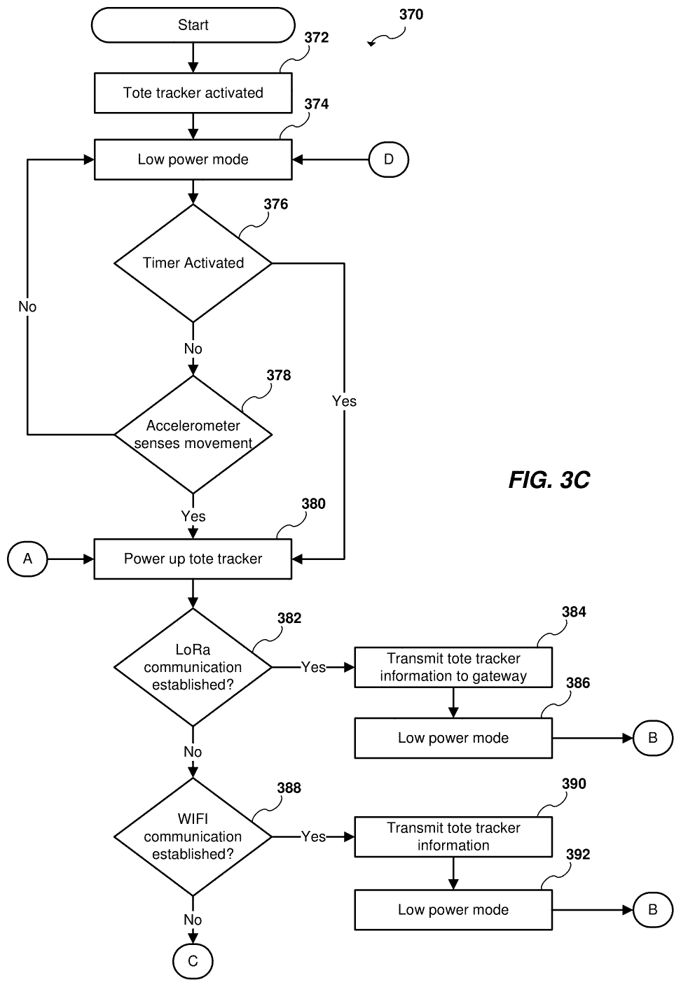

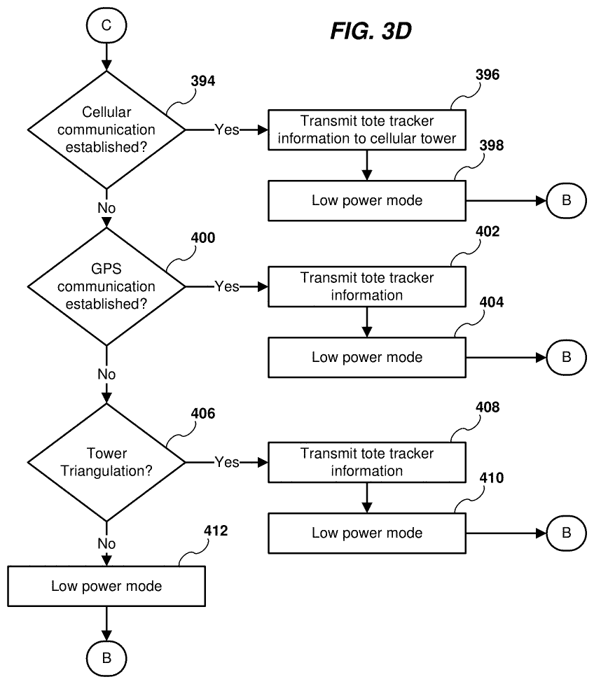

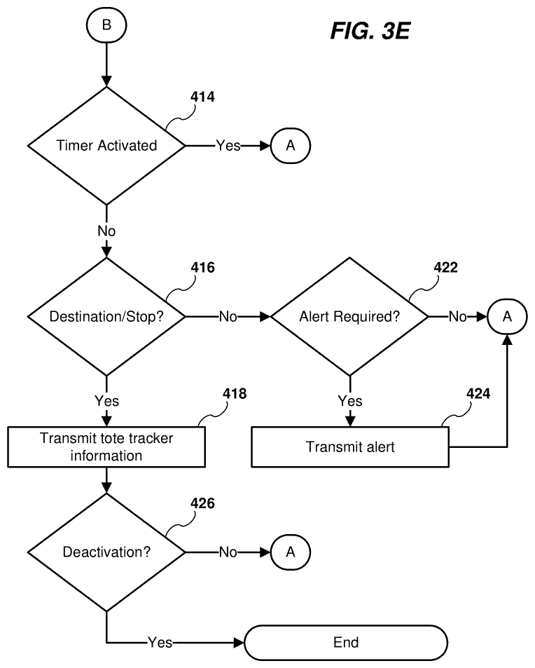

Referring to FIGS. 3A-3B, flow charts illustrating a method for real-time location tracking and monitoring in accordance with an embodiment of the present invention. As shown in FIG. 3A, the present invention includes without limitation an administrative module 302, a location monitoring module 304 and a lock management module 306.

As shown in FIG. 3B, the present invention receives one or more shipping schedules for one or more product containers from a customer at block 352. At block 354, a tote is activated by sending a communication signal by any known means from a central computer to the tote. After activation, the status and geographical location of the tote is monitored at block 356. The tote periodically transmits its status and geographic location to a central computer. Assuming the tote is not moving, these transmissions occur at a predefined slow interval, such as without limitation every 30 minutes. Once the product container within a vehicle trailer begins transportation, then the tot periodically transmits its status and geographic location to a central computer at predefined high interval, such as without limitation every 10 minutes. This frequency may without limitation also occur at a third party cross-dock or up until the product container is delivered to its final destination. Assuming the contents of the product container are for purposes of retail sale, then such final destination is likely the store where it will be sold. Such an arrangement extends the battery life of the tote by limiting the frequency of transmissions when the product container is not likely to change in status and/or geographical location. However, it is understood that the predefined slow interval and the predefined high interval may be any frequency within the scope of the present invention.

Referring to FIGS. 3C-3E, a tote tracker in accordance with an embodiment of the present invention is shown. At block 372, the tote tracker is remotely activated using a graphical user interface. The graphical user interface triggers a communication to the tote tracker 100. This communication may be by any known wireless or wired communication means within the scope of the present invention. Upon activation, the tote tracker 100 enters a low power mode, at block 374. This typically involves the tote tracker 100 setting an timer interrupt and going into a sleep mode until the timer interrupt occurs. At block 376, the tote tracker 100 monitors for whether the timer interrupt has occurred. If the timer has been activated, then at least a portion of the tote tracker 100 is powered up at block 380. At block 378, the tote tracker 100 monitors for whether the accelerometer has sensed movement. If the accelerometer has sensed movement, then at least a portion of the tote tracker 100 is powered up at block 380. At block 382, the tote tracker 100 determines whether a LoRa communication can be established with an external device. If the tote tracker 100 is able to establish a communication with an external gateway device, then the tote tracker 100 communicates its device ID and GPS location to the gateway device which then relays this information to a backend system, at block 384. At block 386, the tote tracker 100 reenters a low power mode for a pre-defined period of time, such as, without limitation, 10 minutes. However, if no movement is detected by the tote tracker 100, then the tote tracker 100 will sleep (a low power mode) for a pre-defined period of time, such as, without limitation, 24 hours.

At block 388, if no communication is established with a LoRa gateway, then the tote tracker 100 will power up the WIFI transceiver 156 and scan for any WIFI access points within range and available in order to determine its physical location. If no WIFI access points are accessible, then the cellular modem 150 will power up and attempt to make communication with a cell tower. If cell tower is successful, then the tote tracker 100 will power up the GPS receiver 152 and try to determine its GPS location, at block 394. At block 400, if the tote tracker 100 is successful in establishing a GPS lock, then it will then send its geographical location information via cellular to a backend system. At block 406, if the tote tracker 100 is not successful in establishing a GPS lock, then it will attempt to triangulate it location via cell towers (less accurate). It will then send its geographical location information via cellular to a backend system. If cellular communication is not established, the tote tracker 100 will then power back down (into a low power mode) and sleep for up to a predefined period of time, such as, without limitation 24 hours, at blocks 402 and 404. This will continue unless movement is detected. When movement is detected, the process starts over.

At blocks 406-410, if the tote tracker 100 is not successful in establishing a GPS lock, then it will attempt to triangulate it location via cell towers (less accurate) and transmit this location. The tote tracker 100 will then power back down (into a low power mode) and sleep for up to a predefined period of time, such as, without limitation 24 hours, at block 412. This will continue unless movement is detected. When movement is detected, the process starts over. At block 416, a determination is made as to whether the tote tracker 100 has reached a predefined destination or stop. If the tote tracker 100 has not reached its predefined destination or stop, then at block 422 a determination is made as to whether the tote tracker 100 has been misdelivered or is outside its shipping schedule. If it is, then an alert signal is communicated to the remote server at block 424.

At block 426, a determination is made as to whether a remote deactivation communication has been received. Processing terminates if the tote tracker 100 has been deactivated.

The present invention may utilize one or more computer applications. As used herein, a “computer application” is a computer executable software application of any type that executes processing instructions on a computer or embedded in a processor, and an “application” or “application project” are the files, objects, structures, database resources and other resources used in integrating a computer application into a software platform.

The term “database” as used herein means a collection of data and is not limited to a relational database or even disk-based storage. It includes, without limitation, relational databases, memcache, Hadoop, or any \other collection of data now known or developed in the future.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

This invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As will be appreciated by one of skill in the art, portions of the invention may be embodied as a method, device, or computer program product. Accordingly, portions of the present invention may take the form of an entirely hardware embodiment or an embodiment combining software and hardware aspects all generally referred to as a “circuit” or “module.”

The present invention includes a computer program product which may be hosted on a computer-usable storage medium having computer-usable program code embodied in the medium and includes instructions which perform the processes set forth in the present specification. The storage medium can include, but is not limited to, any type of disk including floppy disks, optical disks, CD-ROMs, magneto-optical disks, ROMs, RAMs, EPROMs, EEPROMs, flash memory, magnetic or optical cards, or any type of media suitable for storing electronic instructions.

Computer program code for carrying out operations of the present invention may be written in any programming language including without limitation, object-oriented programming languages such as Java®, Smalltalk, C# or C++, conventional procedural programming languages such as the “C” programming language, visually oriented programming environments such as VisualBasic, and the like.

Obviously, many other modifications and variations of the present invention are possible in light of the above teachings. The specific embodiments discussed herein are merely illustrative, and are not meant to limit the scope of the present invention in any manner. It is therefore to be understood that within the scope of the disclosed concept, the invention may be practiced otherwise then as specifically described.

1. A system for real-time location tracking and monitoring of product containers within a network, the system comprising:
a plurality of remote computers in communication with a respective plurality of remote users;
a service provider computer having a computer program stored in non-transient memory and one or more microprocessors;
a network interface in communication with the central server and the plurality of remote computers over a shared network, the network interface being configured to receive one or more transactions via the shared network, wherein the plurality of remote computers have shared access to a shared database on the service provider computer over the shared network;
a shared database in communication with the service provider computer;
an administrative module configured to onboard the plurality of remote users onto the shared network via the network interface, wherein the administrative module includes a permission system, a control system and software tools that manages access permissions to the shared network, wherein the permission system is configured to provide access permissions to the plurality of remote users using predefined configuration settings, the control system includes rules that vary for each of the plurality of entities and by the respective role of the plurality of remote users, and wherein the rules define the read, write, edit and delete permissions and access rights to specific portions of the shared data model; and
a location monitoring module configured to monitor in real-time the status and geographical location of a tote tracker attached to a product container and provide the status and geographical location to at least a portion of the plurality of remote users;
wherein the service provider computer is configured to:
receive location tracking information over a network from the tote tracker;
store the location tracking information in the shared database;
provide access to the shared network to the plurality of remote computers based on the respective access permission of the one of the plurality of remote users provided by the permissibility network module; and
manage access specific portions of the location tracking information for all relevant remote users of the plurality of remote users.

2. The system of claim 1, wherein the location monitoring module contains a GPS receiver for receiving a geographic location and a cellular transceiver for transmitting the geographic location to the service provider computer.

3. A system for real-time location tracking and monitoring of the product container, comprising:
a remote server in communication with a plurality of remote computers over a network;
a product container tracking apparatus detachably connected to a product container, the product container tracking apparatus comprising:
a locking mechanism arranged to attach to a product container door, wherein the locking mechanism is configured to lock and unlock the product container;
a cellular communication unit configured to communicate with the remote server;
a GPS unit configured to determine a location of the product container tracking apparatus;
a memory device for storing a unique identifier for the product container tracking apparatus and data relating to the current status of the product container tracking apparatus;
an accelerometer configured to sense movement of the product container tracking apparatus;
a controller configured to:
periodically receive the current location of the product container tracking apparatus via the GPS unit;
periodically toggle the product container tracking apparatus between a low power mode and an operational power mode, wherein the product container tracking apparatus is initially in a low power mode, and wherein a timer interrupt causes the product container tracking apparatus to toggle to the operational power mode, communicate the unique identifier, location and status of the product container tracking apparatus to the remote sever via the cellular communication unit, and then toggle the product container tracking apparatus back to the low power mode;
upon sensing a starting motion of the product container tracking apparatus by the accelerometer, communicate the unique identifier, location and status of the product container tracking apparatus to the remote sever via the cellular communication unit; and
wherein the remote server communicates the unique identifier, location and status of the product container tracking apparatus to the plurality of remote computers.

4. The system of claim 3, wherein the product container tracking apparatus further comprises a LoRa wireless transceiver configured to periodically communicate the unique identifier, location and status of the product container tracking apparatus to a remote gateway device in communication with the remote server.

5. The system of claim 4, wherein the product container tracking apparatus further comprises a WIFI transceiver configured to periodically communicate the unique identifier, location and status of the product container tracking apparatus to a WIFI hub in communication with the remote server.

6. The system of claim 5, wherein the product container tracking apparatus further comprises a temperature sensor configured to determine the current temperature of the product container tracking apparatus, wherein the status of the product container communicated via the cellular communication unit includes the current temperature of the product container tracking apparatus.

7. The system of claim 6, wherein the locking mechanism is further configured receive a first communication signal to lock the product container and a second communication signal to unlock the product container.

8. The system of claim 6, wherein the controller is further configured to communicate an alert to the remote server when the product container tracking apparatus does not reach its destination according to a predefined schedule or the product container tracking apparatus is delivered to a destination other than the destination defined in the predefined schedule.

9. The system of claim 8, wherein upon receiving the alert, the remote server is configured to communicate the art to the relevant one or more of the plurality of remote computers over the network.
